(19) United States
(12) Patent Application Publication
(10) Pub. No.: US 2003/0165248 A1
(43) Pub. Date: Sep. 4, 2003

(54) Device in hearing aid

(76) Inventors: Franz Vihelm Lenz, Vellinge (SE); Peter Joakim Lenz, Vellinge (SE)

Correspondence Address: BURNS DOANE SWECKER & MATHIS L L P, POST OFFICE BOX 1404, ALEXANDRIA, VA, 22313-1404, US

(21) Appl. No.: 10/362,130

(22) PCT Filed: Aug. 22, 2001
(86) PCT No.: PCT/SE01/01786

(30) Foreign Application Priority Data
Aug. 22, 2000 (SE) 0002966.0

(51) Int. Cl. H04R 25/00

(52) U.S. Cl. 381/312; 381/328; 381/322

(57) ABSTRACT

A hearing device of the kind that has a body (21) adapted to be inserted into the auditory meatus (11) of the user's ear. The body (21) is tubular in shape and contains in its outer end a microphone (24), in its inner end a loudspeaker (25) and an amplifier (26) connected there between. A head (23) is connectable to the body, said head enclosing a battery (27) and having a passage (28) with an inner end which is directed to wards the microphone and an outer end which is directed towards the inner side of the tragus. A housing (22) made of tissue-friendly, flexible material is arranged around the body, which housing when compressed will seek to return to its original shape. The auditory means is ventilated to the outside via this material by means of a passage which is open at both ends, the inner end of which is located in the auditory meatus and the outer end of which opens into the cavity of the auricle adjacent to the anthelix, approximately opposite the tragus.

The present invention relates to a hearing aid of the kind defined in the preamble to claim 1.

### INVENTIVE IDEA

The basic inventive idea is to use the normal functions of the external ear as much as possible when receiving sounds by means of a hearing aid.

### BACKGROUND ART

One problem associated with existing modern hearing aids is that they pick up both direct sound from one or more sound sources or reflected from objects in the vicinity of the device and sound treated by the external ear. This sound mix includes what some call background noise and the overall acoustic image can be described as a ‘noise carpet’. Another problem is the mechanical structure and function of the hearing aid. Normally, the hearing aid is provided with a rigid plastic shell, which fits very closely in the outer end of the auditory meatus and its opening into the cavity of the auricle, and which therefore is tightly pressed against the walls delimiting said parts. This means that sound generated by the person wearing the hearing aid is transmitted to the microphone of the hearing aid and amplified, which is very annoying. Moreover, it cannot be excluded that sounds from the outside also affect the rigid shell and thus, indirectly, the microphone. In addition, the tight fit between the hearing aid and the outer end and opening of the auditory meatus separates the auditory meatus from the rest of the external ear, which is unfavourable in that in a normally functioning ear these parts interact. Through this measure, the auditory meatus is further transformed from an ‘open pipe’ into a ‘closed pipe’ (cf. the pipes of an organ), which will affect the frequency response.

To eliminate the above drawbacks, tests and trials were initiated some years ago; these tests resulted in a construction in which only sound that is treated by the external ear—such sound being influenced by the device only to a very small extent—is amplified and supplied to the internal ear. U.S. Pat. No. 5,920,635 was granted. The problem of sound transmitted from the person wearing the hearing aid to the microphone was solved a long time ago by enclosing the body inserted into the auditory meatus with an expandable plastic material (see for example U.S. Pat. No. 3,983,336). The transformation of the auditory meatus from an open to a closed pipe has also been observed before, and therefore ventilation of the auditory meatus to the outside has been provided—U.S. Pat. No. 4,811,402 and DE Offenlegungsschrift 40 10 372. For some reason, no use has been made of the ideas according to these patents as far as we have been able to ascertain.

### SUMMARY OF THE INVENTION

During the numerous tests of the hearing aid according to U.S. Pat. No. 5,920,635 comprising a body inserted into the auditory meatus which is encased in a housing made of a flexible, expandable material, it turned out, quite surprisingly, that it was possible to ‘open’ the auditory meatus to the outside without causing feedback howls in the hearing aid. Accordingly, first a hole of a relatively small diameter was made in the flexible plastic material enclosing the body adapted to be inserted into the auditory meatus without causing any feedback. The hole was enlarged and still no feedback was detected. The remarkable thing was the change in the character of the sound amplified by means of the hearing aid. The sound became more ‘open’ and its body was increased as when hearing without a hearing aid. The reason for this is really quite natural—the auricle and its parts are allowed to interact in the way nature intended.

The hearing aid according to the invention is thus characterised in that the auditory meatus is ventilated to the outside via the housing made of flexible material, and more specifically by means of at least one passage, which is so dimensioned that, once the housing has been compressed and then expanded so as to engage the wall of the auditory meatus, it forms a ventilation opening between the auditory meatus and the outside, the outer end of the passage being located in the cavity (13) of the auricle adjacent to the anthelix and approximately opposite the tragus (14).

### BRIEF DESCRIPTION OF THE DRAWING

The invention will be described in more detail below with reference to the accompanying drawing illustrating an embodiment of the invention.

FIG. 1 is a view from the side of the user's head illustrating a left ear with a hearing aid according to the invention arranged therein.

FIG. 2 is an enlarged sectional view along the line II-II of FIG. 1.

FIG. 3 is also an enlarged view of an inactive hearing aid according to the invention.

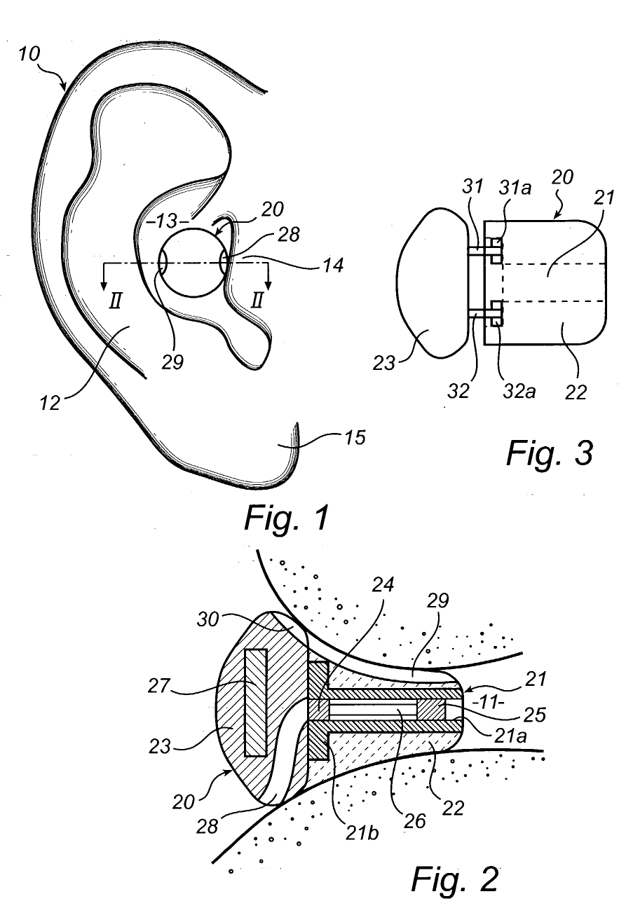

FIGS. 1 and 2 show the external ear 10, which consists of the external auditory meatus 11 (meatus acusticus externus) and the auricle 12 (auricula) with the cavity of the auricle 13 (concha auriculae), the tragus 14 and the earlobe 15 (lobus auriculae). The development of these main parts of the ear has been going on for millions of years and therefore, according to the inventive idea, they should not be by-passed or their function unfavourably influenced by the hearing aid any more than is absolutely necessary.

The illustrated hearing aid 20 according to the invention is essentially of the same kind as the one defined in U.S. Pat. No. 5,920,635, but with some modifications to improve the sound quality.

Thus, the hearing aid 20 consists of a body 21 made of a sound-dampening material and having a tubular section 21a which further out changes into a flange 21b. The body 21 with its cavity is encased in a housing 22 made of a flexible, tissue-friendly material with closed cells, which when compressed will seek to return to its original shape. Such materials are previously known and are used for example in ear defenders. The housing 22 and the body 21 prevent, or at least dampen to a considerable extent, the sound generated by the person wearing the hearing aid, for example speech. The housing 22 is attached to the body 21 in a manner that allows easy removal, for example by means of a simple snap device (not shown), so that the housing, after a few days, can be replaced with a new one, which is advantageous in terms of hygiene.

The sound amplifier device is arranged inside the body 21 and housing 22, which both dampen the sound, said amplifier device consisting of a microphone 24, a loud-speaker 25 and an amplifier 26 connected there between.

A head 23 is connected or connectable to the body 21 comprising the tubular section 21a, the flange 21b and the housing 22, said head having a battery 27 and delimiting, in the embodiment shown, a passage 28, the outer end of which is oriented, according to the U.S. patent mentioned above, towards the inside of the tragus and the inner end of which is oriented towards the microphone 24 of the body.

What characterises the invention is that the housing 22 made of flexible, sound-dampening material provides a ventilation passage from the auditory meatus 11 to the outside. According to the embodiment shown, this is achieved by means of a passage 29, which is more or less diametrically opposed to the opening of the microphone inlet passage 28 provided in the head 23. When the hearing aid is inserted in the user's ear, the opening of the ventilation passage 29 and the opening of the microphone inlet passage will be located on opposite sides of the cavity of the auricle, the former being directed towards the anthelix and the latter towards the inner side of the tragus 14. This arrangement has proven to be advantageous, but the passage 29 could, of course, be arranged differently or several such passages could be provided. If the head 23 blocks the passage 29 from the outside, a recess or a passage may be formed in the circumference of the head, as shown at 30.

In the embodiment shown, the passage 29 has formed out in the housing 22 made of a flexible material. In this connection, it is important that the passage be dimensioned so that, once the flexible material has been compressed and then has expanded so as to engage the wall of the auditory meatus, it is not clogged by the material but forms the desired ventilation passage. The passage 29 may also be provided with a somewhat reinforced wall, for example by solidifying the flexible material around the passage as this is being formed. Naturally, a ventilation tube made of sound-dampening material may be embedded in the housing 22 made of a flexible material. The edges of the housing 22 extending along the body 21 may also be terminated at a distance from one another, i.e. the housing 22 is C-shaped in cross-section. When the housing 22 is compressed around the body 21, the edges are pressed towards each other, even so far as to abut against each other, but are then separated to form the passage 29 as the resilient material expands.

The reason for blocking the auditory meatus by means of the hearing aid, as was done in prior art, was that it had been found that an auditory meatus which was open to the outside meant a considerable risk of feedback between the microphone and the loudspeaker, since the distance between them is very small. It was a surprise, therefore, that no feedback problems occurred if the external auditory meatus was opened via the flexible, sound-dampening material. The best result was achieved as above with the illustrated passage 29, which opens into the cavity 13 of the auricle adjacent to the anthelix, more or less on the opposite side of the tragus 14. In line with the above, it is also conceivable to have a flexible material with open cells or a housing 22 consisting of an outer ring, an inner compressible ring and, positioned therebetween, a grating replacing the flexible material and supporting, the microphone, amplifier and loudspeaker. This has not been tested and it might require the use of a loudspeaker that is not in phase with the microphone, which per se is known within the field of amplifiers.

The hearing aid device illustrated and described is very simple and easy to manufacture. The body 21 and the housing 22 are manufactured and can then be easily joined, and a tube containing the microphone 24, the amplifier 26 and the loudspeaker 25 is then, inserted into the centre cavity of the sleeve. The head 23 comprising the passage 28 is manufactured separately, enclosing the battery 27. As shown in FIG. 3, the head 23 may have two contact pins 31 and 32, which fit non-reversibly in pin bushings 31a and 32a arranged in the flange 21b of the body 21. The hearing aid is activated by pressing the head 23 against the flange 21b and deactivated by separating these parts. For the sake of clarity, no conductors are shown in the drawing, such conductors being obvious to those skilled in the art.

The head 23 comprising the passage 28 and the pins 31, 32 may have the shape of a permanent battery housing, i.e. the battery is permanently encased in the head from the start and when the battery runs out the head is simply replaced by a new head 23. In fact, the whole hearing aid may be designed as a disposable unit, since even the body 21 and the parts thereof can be manufactured at a very low cost using existing technology. It is also possible to use a permanent battery, which is charged by means of induction.

The device according to the invention has no small actuators that are difficult to operate, such as adjusting knob, switch and battery cover. According to battery manufacturers, the battery will last 30-40 days and then the user changes to a new head 23 or a new hearing aid. If greater amplification is required the user also switches to a new hearing aid. All of this is most advantageous, particularly for elderly people.

The most important thing, however, is that people with reasonably impaired hearing can recover their hearing at a reasonable cost and without having to use a device which is difficult to handle and not very attractive from an aesthetic point of view. ‘Reasonably’ here means the hearing loss afflicting people as they grow older and also younger people, who have been afflicted, for example after numerous visits to discotheques. In more serious cases, a more complicated device is probably needed. To insert the device according to the invention first the housing 22 made of flexible material is rolled up between the thumb and the index and the body and its housing are inserted into the external auditory meatus. At the same time, or before, the head 23 is pressed against the body 21 and the device will be operational as soon as the housing engages the wall of the auditory meatus.

The hearing aid according to the invention is small and can, if so desired, be worn without attracting much attention. The outside of the head 23 is smooth and may thus be provided with a decoration, for example a picture, a coating of nacreous or gold or silver like material, which takes away the impression of a hearing aid. It may also be a protruding, decorative object, as long as the object does not interfere with the normal functioning of the external ear. The device is thus turned into an ornament, which also younger people can be persuaded to wear. However, the most important thing is that the invention allows manufacture of a well-functioning device which everybody can afford.

1. A hearing aid device comprising an inwardly open body (21) which is adapted to be inserted into the auditory meatus (11) of the user's ear and which is enclosed by a housing (22) made of flexible, tissue-friendly material, which when compressed will seek to return to its original shape and expand so as to engage the wall of the auditory meatus (11), and a head (23) made of a sound-dampening material which is connected to the body and adapted to be arranged in the cavity (13) of the auricle adjacent to the opening of the auditory meatus, said body (21) containing a microphone (24) in its outwardly facing end, a loudspeaker (25) in its inwardly facing end and an amplifier (26) located therebetween and connected to the microphone and the loudspeaker, and said head (23) having a battery (27) with connections to the amplifier and a passage (28) which is open at both ends, the outer end of which is directed towards the tragus (14) and the inner end of which is connected to the microphone, characterised in that the housing (22) made of a flexible material has at least one passage (29), which is so dimensioned that, once the housing (22) has been compressed and then has expanded so as to engage the wall of the auditory meatus (11), it forms a ventilation opening between the auditory meatus (11) and the outside, the outer end of the passage (29) being located in the cavity (13) of the auricle, adjacent to the anthelix and approximately opposite the tragus (14).
